(19) United States
(12) Patent Application Publication
(10) Pub. No.: US 2009/0015174 A1
(43) Pub. Date: Jan. 15, 2009

(54) LIGHT SOURCE APPARATUS AND DRIVING APPARATUS THEREOF

(75) Inventors: Jui-Feng Huang, Hsinchu City (TW); Lung-Pin Chung, Miaoli County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 11/830,857

(22) Filed: Jul. 31, 2007

(30) Foreign Application Priority Data
Jul. 11, 2007 (TW) 96125235

(51) Int. Cl. H05B 41/16; H05B 41/24

(52) U.S. Cl. 315/250; 315/246

(57) ABSTRACT

A light source apparatus and a driving apparatus thereof are provided. The driving apparatus includes a first node, a second node, a clock synchronization unit, a control unit, a switch unit, and a feedback unit. The driving apparatus receives an AC voltage through the first and the second nodes. The clock synchronization unit converts the AC voltage into a clock synchronization signal. The control unit converts a preset brightness value into a driving current, outputs an adjusting signal according to a timing of the clock synchronization signal, and modulates a pulse width of the adjusting signal according a feedback signal. The switch unit determines whether or not the AC voltage is provided to the light source module according to a control of the adjusting signal. The feedback unit detects a load state of the light source module, and outputs the feedback signal to the control unit according a detection result.

### CROSS-REFERENCE TO RELATED APPLICATION

This application claims the priority benefit of Taiwan application serial no. 96125235, filed Jul. 11, 2007. All disclosure of the Taiwan application is incorporated herein by reference.

### BACKGROUND OF THE INVENTION

1. Field of the Invention

The present invention relates to a light source apparatus and a driving apparatus thereof using an alternating current (AC) to drive a light source.

2. Description of Related Art

Light emitting diodes (LEDs) have functions such as power saving and quick switch speed and are used as state indicators of an electronic apparatus in the past. And now, LEDs have been developed to be used as the backlight of liquid crystal display (LCD), and then the electronic illumination and public display, for example vehicle lamp, traffic light, bulletin board/message marquee, large-scale video wall, even illumination in projector, etc.

Recently, LEDs have been widely used in the backlight module of LCD, for example, used as the light source of small-size LCD backlight for mobile phones and vehicles. However, the application of LEDs in large-scale backlight modules still has many problems to be solved, and the most critical problems involve that the driving efficiency of LEDs is low, the light uniformity is not high, and the price is high, etc. In order to solve the above problems, a conventional direct current (DC) driving apparatus for driving LEDs improves the conversion efficiency and enhances the feedback control of the DC LED driving, so as to improve the light uniformity of LEDs. However, the complexity and the price of the driving apparatus are raised accordingly.

On the other hand, the LED can also be driven by an AC driving apparatus. FIG. 1 is a circuit diagram of using AC to drive LEDs of U.S. Pat. No. 7,081,722B1. Referring to FIG. 1, the AC driving apparatus 100 is divided into four-phase driving architecture by the AC voltage variation to drive LEDs G1-G4. That is to say, the LEDs G1-G4 emit light in sequence, and switches S1-S4 and over-current detecting apparatuses 110-140 are respectively disposed at ends of the LEDs G1-G4. The over-current detecting apparatuses 110-140 have a preset value for adjusting brightness of the LEDs G1-G4. However, the LEDs G1-G4 are at different phases, so the LEDs G1-G4 emit lights of different energies due to different driving time spans. That is, the LED G1 emits light at all four phases, and the LED G4 emits light at only one phase. In this manner, the AC driving apparatus 100 when used in the LCD backlight easily incurs the non-uniformity of light.

### SUMMARY OF THE INVENTION

Accordingly, the present invention is directed to provide a light source apparatus and a driving apparatus thereof, so as to effectively improve the light uniformity and the driving efficiency of the light source module.

The present invention provides a driving apparatus, suitable for driving at least one light source module. The driving apparatus includes a first node, a second node, a clock synchronization unit, a control unit, a switch unit, and a feedback unit. The driving apparatus receives an AC voltage through the first node and the second node. The clock synchronization unit is coupled to the second node, for converting the AC voltage into the clock synchronization signal. The control unit is coupled to the clock synchronization unit, for converting a preset brightness value into a driving current, outputting an adjusting signal according to a timing of the clock synchronization signal, and modulating a pulse width of the adjusting signal according to a feedback signal. The switch unit is coupled to the light source module, for determining whether or not the AC voltage is provided to the light source module according to a control of the adjusting signal. The feedback unit is coupled between the light source module and the control unit, for detecting a load state of the light source module, and outputting the feedback signal according to a detection result.

The present invention provides a light source apparatus. The light source apparatus includes an LED string, a first node, a second node, a clock synchronization unit, a control unit, a switch unit, and a feedback unit. The light source apparatus receives an AC voltage through the first node and the second node. The clock synchronization unit is coupled to the second node, for converting the AC voltage into the clock synchronization signal. The control unit is coupled to the clock synchronization unit, for converting a preset brightness value into a driving current, outputting an adjusting signal according to a timing of the clock synchronization signal, and modulating a pulse width of the adjusting signal according to a feedback signal. The switch unit is coupled to the light source module, for determining whether or not the AC voltage is provided to the LED string according to a control of the adjusting signal. The feedback unit is coupled between the LED string and the control unit, for detecting a load state of the LED string, and outputting the feedback signal according to a detection result.

In the present invention, the clock synchronization unit is used to generate the clock synchronization signal, and the control unit generates the adjusting signal according to the clock synchronization signal to control the on/off of the switch unit, so as to control the time of providing the AC voltage to the light source module. Next, a driving current used to drive the light source module to emit light is transmitted back to the control unit by the feedback unit to be compared with the original preset value. Then, a comparison result is used to modulate the adjusting signal, such that the brightness generated by the light source module can effectively and exactly achieve the preset result.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit diagram of using AC to drive LEDs of U.S. Pat. No. 7,081,722B1.

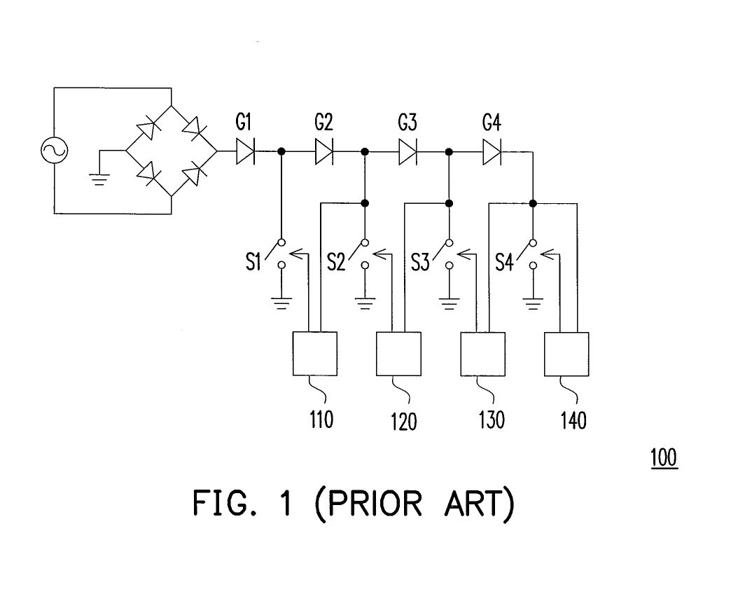

FIG. 2 is a block diagram of a light source apparatus and a driving apparatus according to an embodiment of the present invention.

FIG. 3 is a block diagram of a light source apparatus and a driving apparatus according to an embodiment of the present invention.

FIG. 4 is a circuit diagram of the light source apparatus and the driving apparatus of FIG. 3.

FIG. 5 is a schematic view of waveforms of an AC voltage, a reference voltage, a clock synchronization signal, an adjusting signal, and a feedback signal of FIG. 4.

FIG. 6 is a block diagram of a light source apparatus and a driving apparatus according to an embodiment of the present invention.

FIG. 7 is a circuit diagram of the light source apparatus and the driving apparatus of FIG. 6.

FIG. 8 is a timing diagram of the conduction of an LED string of FIG. 7.

### DESCRIPTION OF EMBODIMENTS

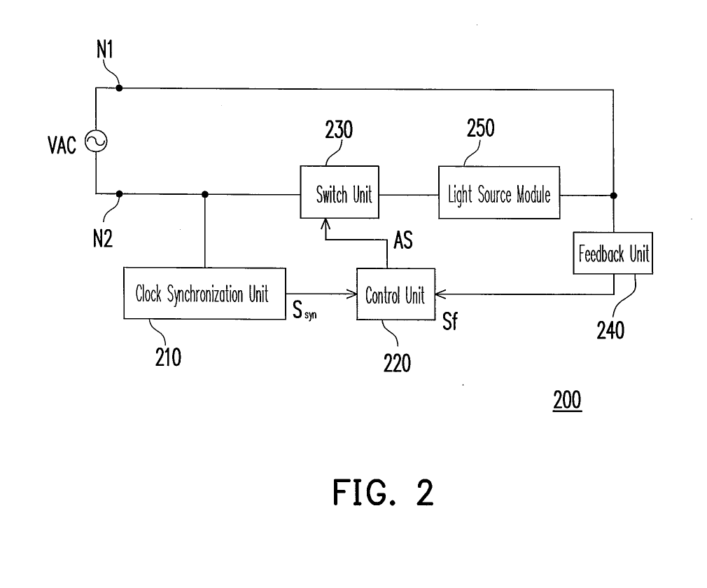

FIG. 2 is a block diagram of a light source apparatus and a driving apparatus according to an embodiment of the present invention. Referring to FIG. 2, the light source apparatus 200 includes a light source module 250 and a driving apparatus. The driving apparatus includes a first node N1, a second node N2, a clock synchronization unit 210, a control unit 220, a switch unit 230, and a feedback unit 240. The light source apparatus 200 receives an AC voltage VAC through the first node N1 and the second node N2, so as to supply a working voltage required by the light source apparatus 200. The first node N1 is coupled to a first end of the light source module 250. The clock synchronization unit 210 is coupled to the second node N2, and converts the received AC voltage VAC into a clock synchronization signal Ssyn.

The control unit 220 is coupled to the clock synchronization unit 210, and the control unit 220 outputs an adjusting signal AS to the switch unit 230 according to a timing of the clock synchronization signal Ssyn. The switch unit 230 is coupled between the second node N2 and a second end of the light source module 250. The switch unit 230 determines whether or not the AC voltage VAC is provided to the light source module 250 according to a state (i.e. a logic high voltage level or a logic low voltage level) of the adjusting signal AS. For example, if the adjusting signal AS is at the logic high voltage level, the switch unit 230 is conducted to provide the AC voltage VAC to the light source module 250, such that the light source module 250 generates the light source. If the adjusting signal AS is at the logic low voltage level, the switch unit 230 is not conducted, such that the AC voltage VAC cannot be provided to the light source module 250.

The feedback unit 240 is coupled between the light source module 250 and the control unit 220, for detecting a load state (e.g. a magnitude of the current value for driving the light source module 250) of the light source module 250, and outputting a feedback signal Sf to the control unit 220 according to a detection result. After the control unit 220 receives the feedback signal Sf, the feedback signal Sf is compared with a preset brightness value (converted driving current), so as to serve as the reference for modulating a pulse width of the adjusting signal AS. For example, if the feedback signal Sf is greater than the preset brightness value (converted driving current), the pulse width of the adjusting signal AS is modulated to be narrower, so as to reduce the conducting time of the switch unit 230. If the feedback signal Sf is smaller than the preset brightness value (converted driving current), the pulse width of the adjusting signal AS is modulated to be wider, so as to increase the conducting time of the switch unit 230. Then, the control unit 220 transmits the modulated adjusting signal AS to the switch unit 230, so as to control the time of providing the AC voltage VAC to the light source module 250, and to make the light source module 250 to achieve the preset brightness value (converted driving current). In this embodiment, the light source module 250 is, for example, an LED string, and plural sets of parallel LED string or bulb string.

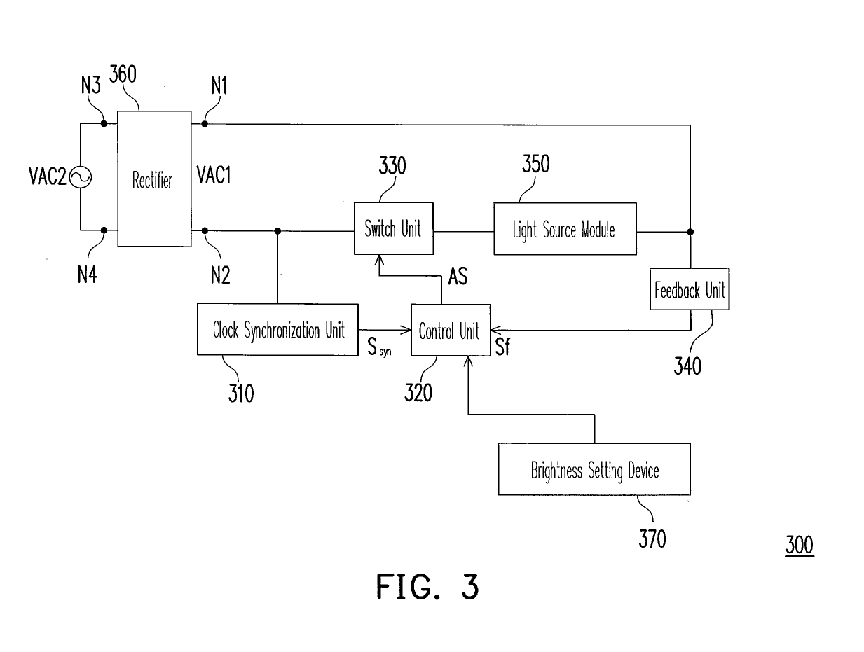

FIG. 3 is a block diagram of a light source apparatus and a driving apparatus according to an embodiment of the present invention. Referring to FIG. 3, the light source apparatus 300 includes a light source module 350 and a driving apparatus. The driving apparatus includes a clock synchronization unit 310, a control unit 320, a switch unit 330, a feedback unit 340, a rectifier 360, and a brightness setting device 370. The light source apparatus 300 receives a second AC voltage VAC2 through a third node N3 and a fourth node N4. By the use of the rectifier 360, the second AC voltage VAC2 may be converted into the AC voltage VAC1 (i.e. a voltage of the first node N1 and a second node N2). The first node N1 is coupled to a first end of the light source module 350.

The clock synchronization unit 310 is coupled to the second node N2, and coverts the received AC voltage VAC1 into a clock synchronization signal Ssyn. The control unit 320 is coupled to the clock synchronization unit 310, and outputs an adjusting signal AS to the switch unit 330 according to a timing of the clock synchronization signal Ssyn. The switch unit 330 is coupled between the second node N2 and a second end of the light source module 350. After the switch unit 330 receives the adjusting signal AS, the AC voltage VAC1 is determined whether or not to be provided to the light source module 350 according to the state (i.e. the logic high voltage level or the logic low voltage level) of the adjusting signal AS, so as to make the light source module 350 to generate the light source. The feedback unit 340 is coupled between the light source module 350 and the control unit 320. The feedback unit 340 is used to detect the load state (e.g. a magnitude of the current value for driving the light source module 350) of the light source module 350, and to output the feedback signal Sf to the control unit 320 according to the detection result.

After the control unit 320 receives the feedback signal Sf, a preset brightness value is firstly acquired from the brightness setting device 370. The magnitude of the preset brightness value can be adjusted freely as required. Then, the control unit 320 will convert the preset brightness value into a driving current and compare the feedback signal Sf with the preset brightness value (converted driving current), so as to serve as the reference for modulating the adjusting signal AS. For example, if the feedback signal Sf is greater than the preset brightness value (converted driving current), the pulse width of the adjusting signal AS is modulated to be narrower. If the feedback signal Sf is smaller than the preset brightness value (converted driving current), the pulse width of the adjusting signal AS is modulated to be wider. Then, the control unit 320 transmits the modulated adjusting signal AS to the switch unit 330, so as to control the time of providing the AC voltage VAC to the light source module 350, and to make the light source module 350 to achieve the preset brightness value (converted driving current). In this embodiment, the light source module 350 is, for example, an LED string, and plural sets of parallel LED string or bulb string. The light source module 350 can be applied to, for example, the illumination equipment, backlight source of the backlight module of the LCD, and the like.

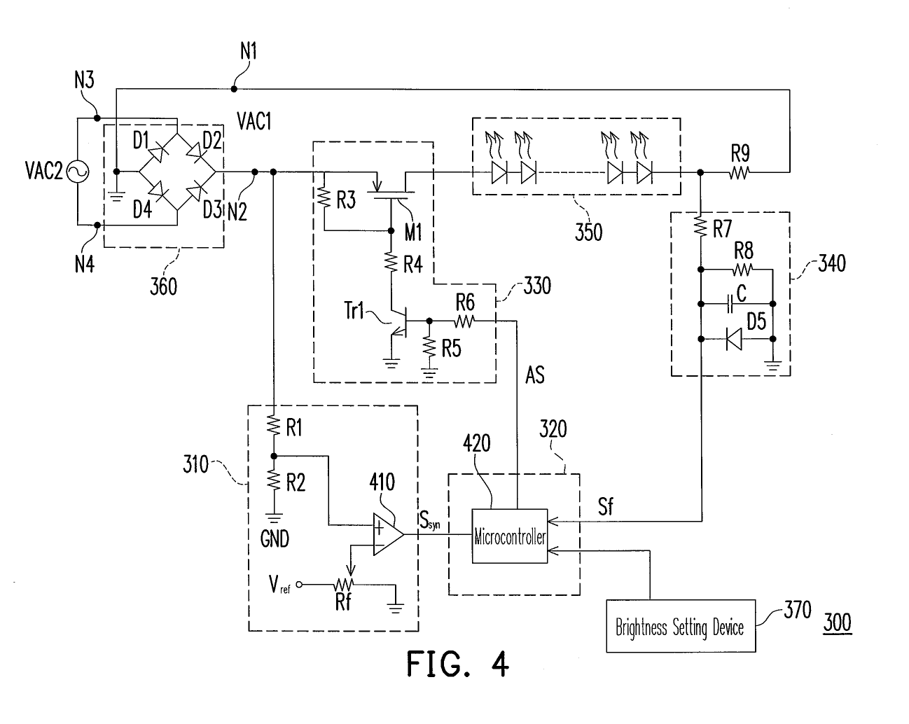

FIG. 4 is a circuit diagram of the light source apparatus and the driving apparatus of FIG. 3. Referring to FIG. 4, in this embodiment, the light source module 350 can be the LED string. The light source apparatus 300 still includes a ninth resistor R9 (current sensing resistor) coupled between the first end of the light source module 350 and the first node N1. The first end of the light source module 350 (e.g. a cathode end of the LED string) is coupled to the first node N1 through the resistor R9, and a second end of the light source module 350 (e.g. an anode end of the LED string) is coupled to the second node N2 through the switch unit 330. Therefore, by the control of the switch unit 330, the AC voltage VAC1 may be determined whether or not to be provided to the light source module 350.

The clock synchronization unit 310 includes a first resistor R1, a second resistor R2, a variable resistor Rf, and a comparator 410. The first end of the resistor R1 is coupled to the second node N2 to receive the AC voltage VAC1. The first end and the second end of the resistor R2 are respectively coupled to the second end of the resistor R1 and a second voltage (e.g. a ground voltage GND). The voltage value of the AC voltage VAC2 may be too large, so if the AC voltage VAC1 is directly input into the comparator 410, the comparator 410 may be damaged. Therefore, the AC voltage VAC1 is firstly divided by the resistors R1 and R2 connected in series, and then the voltage on the resistor R2 is transmitted to the first end (e.g. a positive input end) of the comparator 410.

The first end and the second end of the variable resistor Rf are respectively coupled to a reference voltage Vref and the second voltage (e.g. the ground voltage GND), and the voltage on the variable resistor Rf is transmitted to the second end (e.g. a negative input end) of the comparator 410. After the comparator 410 compares the voltage of the positive input end and the voltage of the negative input end, the output end of the comparator 410 outputs the clock synchronization signal Ssyn. By adjusting the magnitude of the reference voltage Vref or adjusting the resistance value of the variable resistor Rf, the voltage level received by the second end of the comparator 410 can be changed. Due to the different voltage levels of the second end of the comparator 410, the pulse width of the clock synchronization signal Ssyn is adjusted.

The control unit 320 includes a microcontroller 420. After the microcontroller 420 receives the clock synchronization signal Ssyn, the adjusting signal AS is output to the switch unit 330 correspondingly, so as to control whether or not the conducting of the switch unit 330.

The switch unit 330 includes a first transistor M1, a third resistor R3, and a fourth resistor R4, a second transistor Tr1, a fifth resistor R5, and a sixth resistor R6. The drain end and the source end of the transistor M1 are respectively coupled to the second end of the light source module 350 and the second node N2. The first end and the second end of the resistor R3 are respectively coupled to the source end and the gate end of the transistor M1. The first end of the resistor R4 is coupled to the gate end of the transistor M1. The collector end and the emitter end of the transistor Tr1 are respectively coupled to the second end of the resistor R4 and the second voltage (e.g. the ground voltage GND). The first end and the second end of the resistor R5 are respectively coupled to the base end of the transistor TR1 and the second voltage. The first end and the second end of the resistor R6 are respectively coupled to the first end of the resistor R5 and the control unit 320.

In this embodiment, if the adjusting signal AS output by the control unit 330 and received by the base end of the transistor Tr1 is at the logic high voltage level, the transistor Tr1 is conducted. The transistor Tr1 is conducted, so the gate end of the transistor M1 is electrically connected to the ground voltage GND through the resistor R4, such that the transistor M1 is conducted accordingly. After the transistor M1 is conducted, the AC voltage VAC1 may be input to the light source module 350, so as to make the light source module 350 to generate the light source. Otherwise, if the adjusting signal AS output by the control unit 330 and received by the base end of the transistor Tr1 is at the logic low voltage level, the transistor Tr1 is not conducted, and the transistor M1 is not conducted either, so that the AC voltage VAC1 cannot be provided to the light source module 350.

In this embodiment, the transistor M1 is, for example, a PMOS transistor, and the transistor Tr1 is, for example, a bipolar junction transistor. The resistors R3, R4, R5, and R6 may be used as current limiting and assistant conducting elements, so as to prevent an overlarge current flowing to the transistor M1 and the transistor Tr1 to damage the transistor M1 and the transistor Tr1.

The feedback unit 340 includes a seventh resistor R7, an eighth resistor R8, a capacitor C, and a fifth diode D5. The first end of the resistor R7 is coupled to the light source module 350, and the second end of the resistor R7 outputs the feedback signal Sf. The first end and the second end of the resistor R8 are respectively coupled to the second end of the resistor R7 and the second voltage (e.g. the ground voltage GND). The first end and the second end of the capacitor C are respectively coupled to the first end and the second end of the resistor R8. The anode end of the diode D5 is coupled to the second voltage, and the cathode end of the diode D5 is coupled to the second end of the resistor R7. The architecture in the feedback circuit 340 is an integrating circuit, so the feedback unit 340 can convert the driving current that drives the light source module 350 into an average value of the driving current, and the average value of the driving current can be used as the feedback signal Sf, and can be transmitted to the control unit 320.

In this embodiment, a bridge rectifier is used to realize the rectifier 360. People using the present invention would appreciate that other technology can be used to implement the rectifier 360 as required. The rectifier 360 includes diodes D1, D2, D3, and D4. The rectifier 360 receives the AC voltage VAC2 through the third node N3 and the fourth node N4. The anode end of the diode D1 is coupled to the first node N1, and the cathode end of the diode D1 is coupled to the third node N3. The anode end and the cathode end of the diode D2 are respectively coupled to the cathode end of the diode D1 and the second node N2. The anode end and the cathode end of the diode D3 are respectively coupled to the fourth node N4 and the cathode end of the diode D2. The anode end and the cathode end of the diode D4 are respectively coupled to the anode end of the diode D1 and the anode end of the diode D3. In this embodiment, the first node N1 may be grounded.

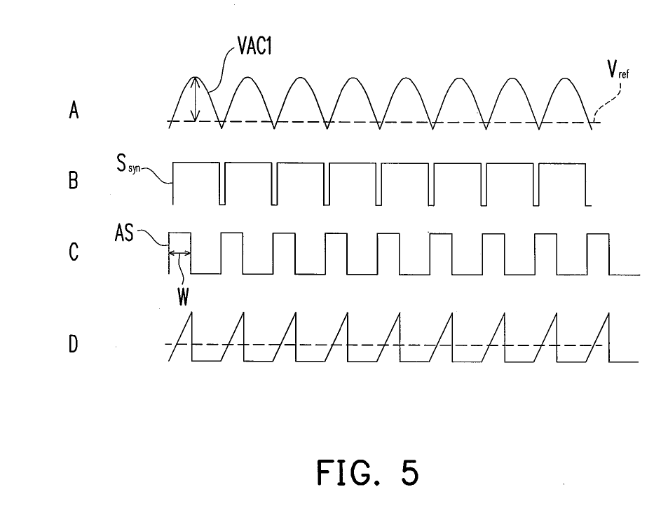

The implementation manner of the light source apparatus 300 is illustrated with reference to the schematic view of waveforms of the voltage and the signal as follows. FIG. 5 is a schematic view of waveforms of the AC voltage VAC1, the reference voltage Vref, the clock synchronization signal Ssyn, the adjusting signal AS, and the feedback signal Sf of FIG. 4. Referring to FIGS. 4 and 5, firstly, the rectifier 360 receives the AC voltage VAC 2 through the third node N3 and the fourth node N4. After the AC voltage VAC2 is rectified by the rectifier 360, the AC voltage VAC2 is firstly converted into the AC voltage VAC1 (e.g. the waveforms of part A as shown in FIG. 5).

Then, after the AC voltage VAC1 is divided by the resistors R1 and R2 in the clock synchronization unit 310, the voltage on the resistor R2 is transmitted to a positive input end of the comparator 410. The voltage received by the negative input end of the comparator 410 is the voltage on the variable resistor Rf (e.g. the dashed line of part A as shown in FIG. 5). Then, the comparator 410 compares the voltage received by the positive input end and the voltage received by the negative input end, and generates a comparison result correspondingly. The comparison result is the clock synchronization signal Ssyn (e.g. part B as shown in FIG. 5). The clock synchronization signal Ssyn is transmitted to the control unit 320.

After receiving the clock synchronization signal Ssyn, the control unit 320 outputs the adjusting signal AS (e.g. part C as shown in FIG. 5) of the logic high voltage level to the switch unit 330 according to the timing of the clock synchronization signal Ssyn, such that the switch unit 330 is conducted. After the switch unit 330 is conducted, the AC voltage VAC1 can be input to the light source module 350, so as to make the light source module 350 to generate the light source. Next, the feedback unit 340 detects the driving current (e.g. solid line waveform of part D as shown in FIG. 5) of the light source module 350, and acquires an average value (e.g. the dashed line of part D as shown in FIG. 5) of the driving current by the integrating circuit in the feedback unit 340. The average driving current value is used as the feedback signal Sf. The feedback signal Sf is transmitted to the microcontroller 420 of the control unit 320.

At this time, the microcontroller 420 acquires the preset brightness value from the brightness setting device 370. Then, the microcontroller 420 converts the preset brightness value into the driving current and compares the feedback signal Sf with the preset brightness value (converted driving current), so as to serve as the reference for modulating the adjusting signal AS. For example, if the feedback signal Sf is greater than the preset brightness value (i.e. the brightness of the light source generated by the light source module 350 is relatively bright), the pulse width W of the adjusting signal AS is modulated to be narrower. If the feedback signal Sf is smaller than the preset brightness value (i.e. the brightness of the light source generated by the light source module 350 is relatively dim), the pulse width W of the adjusting signal AS is modulated to be wider. Then, the modulated adjusting signal AS is further transmitted to the switch unit 330, so as to control the time of inputting the AC voltage VAC1 to the light source module 350, and to make the light source module 350 to achieve the preset brightness value (converted driving current).

However, the present invention is not limited to drive a set of the light source module, may also be used to drive plural sets of light source modules. For example, the present invention is applied to adjust the brightness of the backlight module of the LCD, i.e., to adjust the brightness of RGB in the backlight module. In Another embodiment is illustrated as follows.

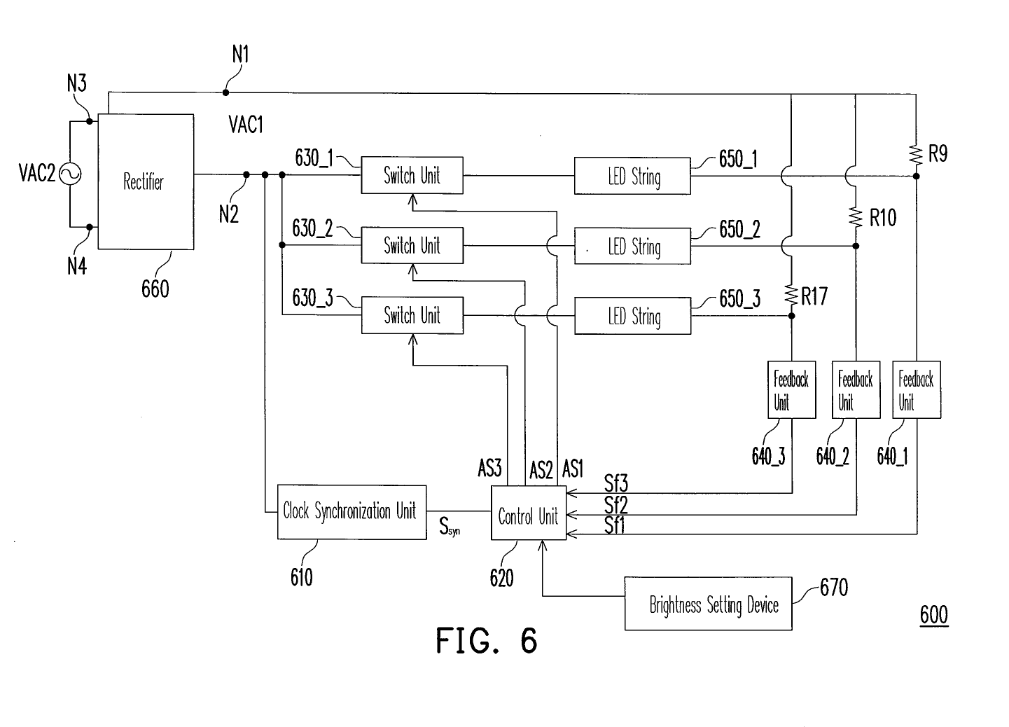

FIG. 6 is a block diagram of a light source apparatus and a driving apparatus according to an embodiment of the present invention. Referring to FIG. 6, the light source apparatus 600 includes LED strings 650_1-650_3 and a driving apparatus. The driving apparatus includes a clock synchronization unit 610, a control unit 620, switch units 630_1-630_3, feedback units 640_1-640_3, LED strings 650_1-650_3, a rectifier 660, a brightness setting device 370, a ninth resistors R9, a tenth resistor R10, and a seventeenth resistor R17. Before the following embodiment is illustrated, firstly the LED string 650_1-650_3 are assumed to be, but not limited to, implemented by red, green, and blue LEDs, respectively.

The resistor R9 (current sensing resistor) is coupled between the first end of the LED string 650_1 and the first node N1. The resistor R10 (current sensing resistor) is coupled between the first end of the LED string 650_2 and the first node N1. The resistor R17 (current sensing resistor) is coupled between the first end of the LED string 650_3 and the first node N1. The rectifier 660 receives the AC voltage VAC2 through the third node N3 and the fourth node N4, and rectifies the AC voltage VAC2, so as to generate the AC voltage VAC1 (i.e. the voltage of the first node N1 and the second node N2). The clock synchronization unit 610 is coupled to the second node N2, and converts the received AC voltage VAC1 into the clock synchronization signal Ssyn.

The control unit 620 is coupled to the clock synchronization unit 610, and outputs the adjusting signals AS1-AS3 sequentially to the switch units 630_1-630_3 according to the timing of the clock synchronization signal Ssyn. After the switch units 630_1-630_3 respectively receives the adjusting signals AS1-AS3, the AC voltage VAC1 is determined whether or not to be provided to the LED strings 650_1-650_3 according to the state of the adjusting signals AS1-AS3, so as to make the LED strings 650_1-650_3 to generate the light source. The feedback units 640_1-640_3 are respectively coupled to the LED strings 650_1-650_3, for detecting the load state (e.g. the magnitude of the current value for driving the LED strings 650_1-650_3) of the LED strings 650_1-650_3, and outputting the feedback signals Sf1-Sf3 sequentially to the control unit 620 according to a detection result.

After receiving the feedback signals Sf1-Sf3 sequentially, the control unit 620 acquires the preset brightness values (converted driving currents) from the brightness setting device 670 firstly. Then, the control unit 620 respectively compares the feedback signals Sf1-Sf3 with the acquired preset brightness values (converted driving currents), so as to serve as the reference for modulating the pulse widths of the adjusting signals AS1-AS3. Then, the control unit 620 transmits the modulated adjusting signals AS1-AS3 sequentially to the switch unit 630, so as to control the time of providing the AC voltage VAC to the LED strings 650_1-650_3, and to make the LED strings 650_1_650_3 to achieve the present brightness values (converted driving currents) respectively.

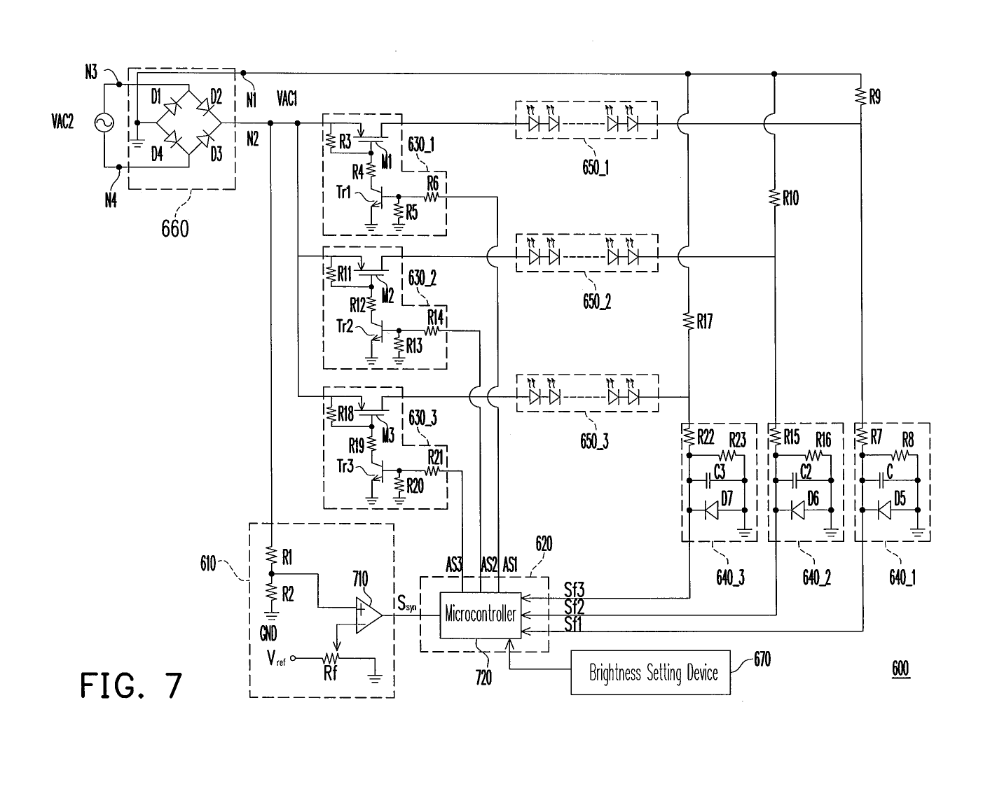

FIG. 7 is a circuit diagram of the light source apparatus and the driving apparatus of FIG. 6. Referring to FIG. 7, the clock synchronization unit 610, the control unit 620, and the rectifier 660 can be implemented with reference to FIG. 4, and the details will not be described herein again. In this embodiment, the bridge rectifier is used to realize the rectifier 660. People using the present invention would appreciate that other technology can also be used to implement the rectifier 660 as required. The switch unit 630_1 includes a first transistor M1, a third resistor R3, a fourth resistor R4, a second transistor Tr1, a fifth resistor R5, and a sixth resistor R6. The drain end of the transistor M1 is coupled to the second end of the LED string 650_1. The first end and the second end of the resistor R3 are respectively coupled to the source end and the gate end of the transistor M1. The first end of the resistor R4 is coupled to the gate end of the transistor M1. The collector end and the emitter end of the transistor Tr1 are respectively coupled to the second end of the resistor R4 and the second voltage (e.g. the ground voltage GND). The first end and the second end of the resistor R5 are respectively coupled to the base end of the transistor Tr1 and the second voltage. The first end and the second end of the resistor R6 are respectively coupled to the first end of the resistor R5 and the control unit 620. In this embodiment, the transistor M1 is, for example, a PMOS transistor, and the transistor Tr1 is, for example, a bipolar junction transistor.

The switch unit 630_2 includes a third transistor M2, an eleventh resistor R11, a twelfth resistor R12, a fourth transistor Tr2, a thirteenth resistor R13, and a fourth resistor R14. The drain end and the source end of the transistor M2 are respectively coupled to the second end of the LED string 650_2 and the second node N2. The first end and the second end of the resistor R11 are respectively coupled to the source end and the gate end of the transistor M2. The first end of the resistor R12 is coupled to the gate end of the transistor M2. The collector end and the emitter end of the transistor Tr2 are respectively coupled to the second end of the resistor R12 and the second voltage (e.g. the ground voltage GND). The first end and the second end of the resistor R13 are respectively coupled to the base end of the transistor Tr2 and the second voltage. The first end and the second end of the resistor R14 are respectively coupled to the first end of the resistor R13 and the control unit 620. In this embodiment, the transistor M2 is, for example, a PMOS transistor, and the transistor Tr2 is, for example, a bipolar junction transistor.

The switch unit 630_3 includes a fifth transistors M3, an eighteenth resistor R18, a nineteenth resistor R19, a sixth transistor Tr3, a twentieth resistor R20, and a twenty-first resistor R21. The drain end and the source end of the transistor M3 are respectively coupled to the second end of the LED string 650_3 and the second node N2. The first end and the second end of the resistor R18 are respectively coupled to the source end and the gate end of the transistor M3. The first end of the resistor R19 is coupled to the gate end of the transistor M3. The collector end and the emitter end of the transistor Tr3 are respectively coupled to the second end of the resistor R19 and the second voltage (e.g. the ground voltage GND). The first end and the second end of the resistor R20 are respectively coupled to the base end of the transistor Tr3 and the second voltage. The first end and the second end of the resistor R21 are respectively coupled to the first end of the resistor R20 and the control unit 620. In this embodiment, the transistor M3 is, for example, a PMOS transistor, and the transistor Tr3 is, for example, a bipolar junction transistor. The operation of the switch units 630_1-630_3 is similar to that of the switch unit 330 of FIG. 4, and the details will not be described herein again.

The feedback unit 640_1 includes a seventh resistor R7, an eighth resistor R8, a capacitor C, and a fifth diode D5. The first end of the resistor R7 is coupled to the LED string 650_1, and the second end of the resistor R7 outputs the feedback signal Sf1. The first end and the second end of the resistor R8 are respectively coupled to the second end of the resistor R7 and the second voltage (e.g. the ground voltage GND). The first end and the second end of the capacitor C are respectively coupled to the first end and the second end of the resistor R8. The anode end of the diode D5 is coupled to the second voltage, and the cathode end of the diode D5 is coupled to the second end of the resistor R7.

The feedback unit 640_2 includes a fifteenth resistor R15, a sixteenth resistor R16, a capacitor C2, and a sixth diode D6. The first end of the resistor R15 is coupled to the LED string 650_2, and the second end of the resistor R15 outputs the feedback signal Sf2. The first end and the second end of the resistor R16 are respectively coupled to the second end of the resistor R15 and the second voltage. The first end and the second end of the capacitor C2 are respectively coupled to the first end and the second end of the resistor R16. The anode end of the diode D6 is coupled to the second voltage, and the cathode end of the diode D6 is coupled to the second end of the resistor R15.

The feedback unit 640_3 includes a twenty-second resistor R22, a twenty-third resistor R23, a capacitor C3, and a seventh diode D7. The first end of the resistor R22 is coupled to the LED string 650_3, and the second end of the resistor R22 outputs the feedback signal Sf3. The first end and the second end of the resistor R23 are respectively coupled to the second end of the resistor R22 and the second voltage. The first end and the second end of the capacitor C3 are respectively coupled to the first end and the second end of the resistor R23. The anode end of the diode D7 is coupled to the second voltage, and the cathode end of the diode D7 is coupled to the second end of the resistor R22. The operation of the feedback units 640_1-640_3 is similar to that of the feedback unit 340 of FIG. 4, and the details will not be described herein again.

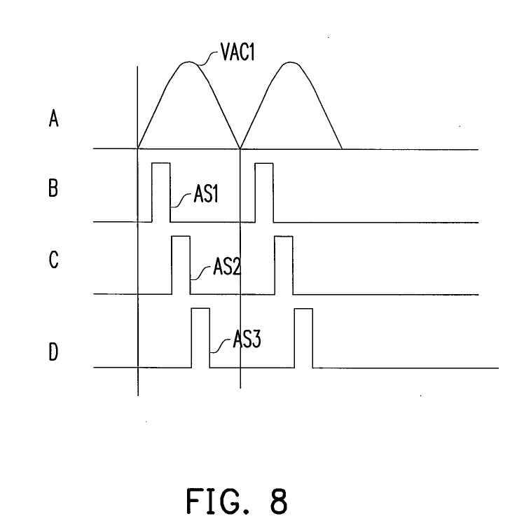

The implementation manner of the light source apparatus 600 is illustrated with reference to the schematic view of waveform of the adjusting signal as follows. FIG. 8 is a timing diagram of the conduction of the LED string of FIG. 7. Referring to FIGS. 7 and 8, firstly, the rectifier 660 receives the AC voltage VAC2 through the node N3 and the node N4, and after the AC voltage VAC2 is rectified by the rectifier 360, the AC voltage VAC2 is firstly converted into the AC voltage VAC1 (e.g. the waveform of part A as shown in FIG. 8).

Then, after receiving the clock synchronization signal Ssyn, the control unit 620 outputs the adjusting signals AS1-AS3 (e.g. parts B to D as shown in FIG. 8) sequentially to the switch units 630_1-630_3, such that the switch units 630_1-630_3 are conducted. After the switch units 630_1-630_3 are conducted in sequence, the AC voltage VAC1 may be input to the LED strings 650_1-650_3, so as to make the LED strings 650_1-650_3 to generate the light source. Then, the feedback units 640_1-640_3 respectively receive the driving current for driving the LED strings 650_1-650_3, and then generate the feedback signals Sf1-Sf3 in sequence. The feedback signals Sf1-Sf3 may be transmitted to a microcontroller 720 of the control unit 620.

At this time, the microcontroller 720 acquires the preset brightness values (converted driving currents) from the brightness setting device 670, and respectively compares the feedback signals Sf1-Sf3 with the preset brightness values (converted driving currents), so as to serve as the reference for modulating the adjusting signals AS1-AS3. Then, the modulated adjusting signals AS1-AS3 are transmitted to the switch units 630_1-630_3, so as to control the time of inputting the AC voltage VAC1 to the LED strings 650_1-650_3, and to make the LED strings 650_1-650_3 to achieve the preset brightness values (converted driving currents) respectively.

It should be noted that the embodiment use an AC power source to drive the light source module and the LED string instead of using a DC power source, so the AC-DC converter may be omitted, and the cost of the used elements are reduced. In addition, this embodiment can make the light source module have good light uniformity, so the light source module can also be used as the backlight source of the backlight module of a direct type LCD.

To sum up, the present invention uses the clock synchronization unit to generate the clock synchronization signal, and the control unit to generate the adjusting signal according to the clock synchronization signal so as to control the on/off of the switch unit, thereby controlling the time of providing the AC voltage to the light source module. After that, a driving current used to drive the light source module to emit light is transmitted back to the control unit by the feedback unit, so as to be compared with the original preset value. Then, the comparison result is used to modulate the adjusting signal, so as to make the brightness generated by the light source module to achieve the preset result effectively and exactly. Therefore, the present invention can effectively enhance the light uniformity and the driving efficiency of the light source module, the design of the driving apparatus is simple, and it is easy to be realized in products.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A driving apparatus, suitable for driving at least one light source module, comprising:
A first node and a second node, wherein the first node is coupled to the light source module, and the driving apparatus receives an alternating current (AC) voltage through the first node and the second node;
a clock synchronization unit, coupled to the second node, for converting the AC voltage into a clock synchronization signal;
a control unit, coupled to the clock synchronization unit, for converting a preset brightness value into a driving current, outputting an adjusting signal according to a timing of the clock synchronization signal, and modulating a pulse width of the adjusting signal according to a feedback signal;
a switch unit, coupled between the second node and the light source module, for determining whether or not the AC voltage is provided to the light source module according to a control of the adjusting signal; and
a feedback unit, coupled between the light source module and the control unit, for detecting a load state of the light source module, and outputting the feedback signal according to a detection result.

2. The driving apparatus as claimed in claim 1, wherein the light source module comprises a light emitting diode (LED) string.

3. The driving apparatus as claimed in claim 1, further comprising:
a rectifier, coupled between the first node and the second node, for generating the AC voltage according to a second AC voltage.

4. The driving apparatus as claimed in claim 3, wherein the rectifier comprises a bridge rectifier.

5. The driving apparatus as claimed in claim 1, wherein the first node is grounded.

6. The driving apparatus as claimed in claim 1, wherein the clock synchronization unit comprises:
a first resistor, having a first end coupled to the second node;
a second resistor, having a first end coupled to a second end of the first resistor, and a second end coupled to a second voltage;
a variable resistor, having a first end coupled to a reference voltage, and a second end coupled to the second voltage; and
a comparator, having a first input end coupled to the first end of the second resistor, a second input end coupled to the variable resistor, and an output end outputting the clock synchronization signal.

7. The driving apparatus as claimed in claim 6, wherein the second voltage is a ground voltage.

8. The driving apparatus as claimed in claim 1, wherein the control unit comprises:
a microcontroller, coupled to the clock synchronization unit, the switch unit, and the feedback unit, wherein the microcontroller converts the preset brightness value into the driving current, outputs the adjusting signal according to the synchronization clock signal, and modulates the pulse width of the adjusting signal according to the feedback signal provided by the feedback unit.

9. The driving apparatus as claimed in claim 1, wherein the switch unit comprises:
a first transistor, having a drain end coupled to the light source module and a source end coupled to the second node;
a third resistor, having a first end and a second end respectively coupled to the source end and a gate end of the first transistor;
a fourth resistor, having a first end coupled to the gate end of the first transistor;
a second transistor, having a collector end coupled to a second end of the fourth resistor, and an emitter end coupled to a second voltage;
a fifth resistor, having a first end coupled to a base end of the second transistor, and a second end coupled to the second voltage; and
a sixth resistor, having a first end coupled to the first end of the fifth resistor, and a second end coupled to the control unit to receive the adjusting signal.

10. The driving apparatus as claimed in claim 9, wherein the first transistor is a PMOS transistor.

11. The driving apparatus as claimed in claim 9, wherein the second transistor is a bipolar junction transistor.

12. The driving apparatus as claimed in claim 1, wherein the feedback unit comprises:
a seventh resistor, having a first end coupled to the light source module, and a second end outputting the feedback signal;
an eighth resistor, having a first end coupled to the second end of the seventh resistor, and a second end coupled to a second voltage;
a capacitor, having a first end coupled to the second end of the seventh resistor, and a second end coupled to the second voltage; and
a fifth diode, having an anode end coupled to the second voltage, and a cathode end coupled to the second end of the seventh resistor.

13. The driving apparatus as claimed in claim 1, further comprising:
a ninth resistor, coupled between the light source module and the first node.

14. A light source apparatus, comprising:
an LED string;
a first node and a second node, wherein the first node is coupled to a first end of the LED string, and the light source apparatus receives an AC voltage through the first node and the second node;
a clock synchronization unit, coupled to the second node, for converting the AC voltage into a clock synchronization signal;
a control unit, coupled to the clock synchronization unit, for converting a preset brightness value into a driving current, outputting an adjusting signal according to a timing of the clock synchronization signal, and modulating a pulse width of the adjusting signal according to a feedback signal;
a switch unit, coupled between the second node and a second end of the LED string, for determining whether or not the AC voltage is provided to the LED string according to a control of the adjusting signal; and
a feedback unit, coupled between the LED string and the control unit, for detecting a load state of the LED string, and outputting the feedback signal according to a detection result.

15. The light source apparatus as claimed in claim 14, further comprising:
a rectifier, coupled between the first node and the second node, for generating the AC voltage according to a second AC voltage.

16. The light source apparatus as claimed in claim 15, wherein the rectifier comprises a bridge rectifier.

17. The light source apparatus as claimed in claim 14, wherein the first node is grounded.

18. The light source apparatus as claimed in claim 14, wherein the clock synchronization unit comprises:
a first resistor, having a first end coupled to the second node;
a second resistor, having a first end coupled to a second end of the first resistor, and a second end coupled to a second voltage;
a variable resistor, having a first end coupled to a reference voltage, and a second end coupled to the second voltage; and
a comparator, having a first input end coupled to the first end of the second resistor, a second input end coupled to the variable resistor, and an output end outputting the clock synchronization signal.

19. The light source apparatus as claimed in claim 18, wherein the second voltage is a ground voltage.

20. The light source apparatus as claimed in claim 14, wherein the control unit comprises:
a microcontroller, coupled to the clock synchronization unit, the switch unit, and the feedback unit, wherein the microcontroller converts the preset brightness value into the driving current, outputs the adjusting signal according to the synchronization clock signal, and modulates the pulse width of the adjusting signal according to the feedback signal provided by the feedback unit.

21. The light source apparatus as claimed in claim 14, wherein the switch unit comprises:
a first transistor, having a drain end coupled to a second end of the LED string, and a source end coupled to the second node;
a third resistor, having a first end and a second end respectively coupled to the source end and a gate end of the first transistor;
a fourth resistor, having a first end coupled to the gate end of the first transistor;
a second transistor, having a collector end coupled to a second end of the fourth resistor, and an emitter end coupled to a second voltage;
a fifth resistor, having a first end coupled to a base end of the second transistor, and a second end coupled to the second voltage; and
a sixth resistor, having a first end coupled to the first end of the fifth resistor, and a second end coupled to the control unit to receive the adjusting signal.

22. The light source apparatus as claimed in claim 21, wherein the first transistor is a PMOS transistor.

23. The light source apparatus as claimed in claim 21, wherein the second transistor is a bipolar junction transistor.

24. The light source apparatus as claimed in claim 14, wherein the feedback unit comprises:
a seventh resistor, having a first end coupled to the LED string, and a second end outputting the feedback signal;
an eighth resistor, having a first end coupled to the second end of the seventh resistor, and a second end coupled to a second voltage;
a capacitor, having a first end coupled to the second end of the seventh resistor, and a second end coupled to the second voltage; and
a fifth diode, having an anode end coupled to the second voltage, and a cathode end coupled to the second end of the seventh resistor.

25. The light source apparatus as claimed in claim 14, further comprising:
a ninth resistor, coupled between the first end of the LED string and the first node.

26. The light source apparatus as claimed in claim 14, further comprising:
a second LED string, having a first end coupled to the first node;
a second switch unit, coupled between the second node and a second end of the second LED string, for determining whether or not the AC voltage is provided to the second LED string according to a control of a second adjusting signal; and
a second feedback unit, coupled between the second LED string and the control unit, for detecting a load state of the second LED string, and outputting a second feedback signal according to a detection result;
wherein the control unit convert a second preset brightness value into a second driving current, outputs the second adjusting signal according to the timing of the clock synchronization signal, and modulates a pulse width of the second adjusting signal according to the second feedback signal.

27. The light source apparatus as claimed in claim 26, wherein the second switch unit comprises:
a third transistor, having a drain end coupled to the second end of the second LED string, and a source end coupled to the second node;
an eleventh resistor, having a first end and a second end respectively coupled to the source end and a gate end of the third transistor;
a twelfth resistor, having a first end coupled to the gate end of the third transistor;
a fourth transistor, having a collector end coupled to a second end of the twelfth resistor, and an emitter end coupled to a second voltage;
a thirteenth resistor, having a first end coupled to a base end of the fourth transistor, and a second end coupled to the second voltage; and
a fourteenth resistor, having a first end coupled to the first end of the thirteenth resistor, and a second end coupled to the control unit to receive the second adjusting signal.

28. The light source apparatus as claimed in claim 27, wherein the third transistor is a PMOS transistor.

29. The light source apparatus as claimed in claim 27, wherein the fourth transistor is a bipolar junction transistor.

30. The light source apparatus as claimed in claim 26, wherein the second feedback unit comprises:
a fifteenth resistor, having a first end coupled to the second LED string, and a second end outputting the second feedback signal;
a sixteenth resistor, having a first end coupled to the second end of the fifteenth resistor, and a second end coupled to a second voltage;
a second capacitor, having a first end coupled to the second end of the fifteenth resistor, and a second end coupled to the second voltage; and
a sixth diode, having an anode end coupled to the second voltage, and a cathode end coupled to the second end of the fifteenth resistor.

31. The light source apparatus as claimed in claim 26, further comprising:
a tenth resistor, coupled between the first end of the second LED string and the first node.

32. The light source apparatus as claimed in claim 26, further comprising:
a third LED string, having a first end coupled to the first node;
a third switch unit, coupled between the second node and a second end of the third LED string, for determining whether or not the AC voltage is provided to the third LED string according to a control of a third adjusting signal; and
a third feedback unit, coupled between the third LED string and the control unit, for detecting a load state of the third LED string, and outputting a third feedback signal according to a detection result;
wherein the control unit converts a third preset brightness value into a third driving current, further outputs the third adjusting signal according to the timing of the clock synchronization signal, and modulates a pulse width of the third adjusting signal according to the third feedback signal.

33. The light source apparatus as claimed in claim 32, wherein the third switch unit comprises:
a fifth transistor, having a drain end coupled to the second end of the third LED string, and a source end coupled to the second node;
an eighteenth resistor, having a first end and a second end respectively coupled to the source end and a gate end of the fifth transistor;
a nineteenth resistor, having a first end coupled to a gate end of the fifth transistor;
a sixth transistor, having a collector end coupled to a second end of the nineteenth resistor, and an emitter end coupled to a second voltage;
a twentieth resistor, having a first end coupled to a base end of the sixth transistor, and a second end coupled to the second voltage; and
a twenty-first resistor, having a first end coupled to the first end of the twentieth resistor, and a second end coupled to the control unit to receive the third adjusting signal.

34. The light source apparatus as claimed in claim 33, wherein the fifth transistor is a PMOS transistor.

35. The light source apparatus as claimed in claim 33, wherein the sixth transistor is a bipolar junction transistor.

36. The light source apparatus as claimed in claim 32, wherein the third feedback unit comprises:
a twenty-second resistor, having a first end coupled to the third LED string, and the second end outputting the second feedback signal;
a twenty-third resistor, having a first end coupled to the second end of the twenty-second resistor, and a second end coupled to a second voltage;
a third capacitor, having a first end coupled to the second end of the twenty-second resistor, and a second end coupled to the second voltage; and
a seventh diode, having an anode end coupled to the second voltage, and a cathode end coupled to the second end of the twenty-second resistor.

37. The light source apparatus as claimed in claim 32, further comprising:
a seventeenth resistor, coupled between the first end of the third LED string and the first node.

38. The light source apparatus as claimed in claim 14, wherein the light source apparatus is a backlight module of a display.
